(19) United States
(12) Patent Application Publication
(10) Pub. No.: US 2024/0363273 A1
(43) Pub. Date: Oct. 31, 2024

(54) Magnetic Composite Material Composition, Magnetic Core For Inductor And Manufacturing Method Therefor

(71) Applicant: HENGDIAN GROUP DMEGC MAGNETICS CO.,LTD., Dongyang, Zhejiang (CN)

(72) Inventors: Leijie WANG, Dongyang, Zhejiang (CN); Yangdong YU, Dongyang, Zhejiang (CN); Quan ZHU, Dongyang, Zhejiang (CN); Fei WANG, Dongyang, Zhejiang (CN); Kang YI, Dongyang, Zhejiang (CN)

(21) Appl. No.: 18/029,100

(22) PCT Filed: May 24, 2022
(86) PCT No.: PCT/CN2022/094761

§ 371 Date: Mar. 29, 2023

(30) Foreign Application Priority Data
Nov. 3, 2021 (CN) 202111294793.9

(51) Int. Cl. H01F 1/147; B22F 1/107; B22F 3/22; B22F 3/24; B22F 9/04; H01F 41/02

(52) U.S. Cl. CPC H01F 1/14791; B22F 1/107; B22F 3/22; B22F 3/24; B22F 9/04; H01F 1/14766; H01F 41/0246; B22F 2003/248; B22F 2009/043; B22F 2301/35; B22F 2998/10

(57) ABSTRACT

The present disclosure provides a magnetic composite material composition, a magnetic core for an inductor and a manufacturing method therefor. It includes a magnetically soft alloy, a thermosetting resin, a curing agent, and an organic solvent. The organic solvent contains at least two types of volatile solvents, and a difference between boiling points of the volatile solvents ranges from 100 to 170° C. The magnetically soft alloy and the thermosetting resin may be cured and formed under the action of the curing agent. The magnetic composite material of the above composition has good high-temperature resistance. Different types of the volatile solvents may be successively volatilized rather than rapidly volatilized at one time as the curing reaction undergoes. Therefore, a large amount of pores can be prevented from being produced on the surface and internal of the magnetic composite material composition, thereby enhancing the compactness and relative permeability.

### CROSS-REFERENCE TO RELATED APPLICATION

This application is based on Chinese Patent Application No. 2021112947993.9, filed on Nov. 3, 2021, which claims the benefit of priority to the Chinese Patent Application, which is incorporated by reference in its entirety herein.

### TECHNICAL FIELD

The present disclosure relates to the technical field of integrated inductors, and specifically, to a magnetic composite material composition, a magnetic core for an inductor and a manufacturing method therefor.

### BACKGROUND

Currently, there are many manufacturing processes of integrated chip inductors. Basic methods include: (1) winding a hollow coil in advance, putting the hollow coil in a mold cavity of a mold, then filling prepared magnetically soft alloy power into a mold to obtain a body blank of the integrated inductor, and then performing subsequent steps of curing and electrode manufacturing; and (2) prefabricating a core first, then manufacturing a combined body of a core and a coil, putting the combined body of the core and the coil into a mold, then filling a powder into the mold, obtaining an inductor body blank through compression molding, and then performing the subsequent steps of curing and electrode manufacturing.

However, the conventional integrated inductor has some defect, for example, as followings: (1) pressure casting is required to be performed on an inductor during inductor manufacturing, the selection of the pressure of a molding machine in a pressure casting process has a great impact on the performance of the finally molded inductor; and damage to the enameled wire of the coil or coil deformation may be caused due to excessive pressure, so that there is a limitation to coils with complex shapes; (2) a mode made of a special material is still required during pressure casting, so that the production of magnetic cores with complex shapes is limited; (3) the pressure casting process has a requirement for the size of the inductor, which limits the development of large size inductors; and (4) a molded inductor process is complex relative to a conventional inductor process and is high in cost.

An current literature disclosed a method for preparing a injection molding plastic and soft magnetic composite material, which included preparing a soft magnetic product having a complex three-dimensional structure by one-step molding a composite material containing 80 to 90 parts of soft magnetic powder, 8 to 18 parts of high-speed flow plastic, 0.08 to 0.09 parts of a coupling agent, 8 to 9 parts of a solvent, 1 to 2 parts of a plasticizer, and 0.1 to 0.3 parts of an antioxygen by means of an injection molding process. However, the soft magnetic product prepared by the method can not work in a high-temperature environment (100 to 180° C.). The preparing process was relatively complex and needs to perform crushing and granulation after obtaining rubber compound.

An current literature disclosed a method for preparing a polyethylene matrix injection-molded magnetic composite material for an inductor. The polyethylene matrix injection-molded magnetic composite material was prepared by the following components, by weight percentage, 5% to 30% of a polyethylene base material, 70% to 95% of a magnetic filler, 1% to 4% of a coupling agent, and 1% to 4% of other auxiliaries. The method for preparing a polyethylene matrix injection-molded magnetic composite material included the following steps: step A, crushing the polyethylene base material to obtain polyethylene powder; step B, hydrolyzing the coupling agent to obtain a coupling agent hydrolyzate, and then dispersing the coupling agent hydrolyzate into the magnetic filler to perform surface modification on the magnetic filler; step C, mixing substances obtained in steps A and B, adding other auxiliaries, and mixing; and step D, adding the mixture obtained in step C to an extruding machine for melt extrusion to obtain the polyethylene matrix injection-molded magnetic composite material. The polyethylene matrix injection-molded magnetic composite material had good mechanical strength during the filling of the magnetic filler. However, the adopted was relatively complex, and the prepared soft magnetic composite material cannot work in the high-temperature environment (100 to 180° C.).

Another current literature disclosed a low temperature cured high-frequency and low-loss NiCuZn ferrite magnetic core material and a pressureless injection molding method. 2.5 wt. % of a methacrylamide monomer aqueous solution. N,N′-methylenebisacrylamide, and 10 wt. % of a polyethylene glycol 400 plasticizer aqueous solution were mixed as a premix, and a cementitious slurry was obtained by adding NiCuZn ferrite powder into the premix. An ammonium persulfate aqueous solution and tetramethylethylene diamine were added to the slurry, and then the mixture was injected into the mold. Demoulding was performed after curing at normal temperature and pressure, and the body blank was dried, then sintering and cooling to obtain the core. Through the above preparation method. the core may be cured and formed at room temperature without applying ambient pressure. However, the preparation of the core can be completed indeed after the core prepared by the above method was still required to be sintered subsequently in an environment ranging from 900 to 1000° C. If the inductor is manufactured together by the above slurry and the coil, the coil may be damaged.

On this basis, it is of great significance to research and develop a magnetic core for an inductor that may normally work at 100 to 180° C. and has good compactness and high relative permeability. In addition, in order to prevent damage to the coil during preparation, it is also of great significance to adopt a preparation method which does not require pressure casting.

### SUMMARY

The present disclosure is mainly intended to provide a magnetic composite material composition, a magnetic core for an inductor and a manufacturing method therefor, to resolve problems that the preparation process of a conventional integrated inductor is complicated, a coil is damaged during pressure casting, and the integrated inductor magnetic core is poor in high-temperature resistance (100 to 180° C.) and difficult to have good high-temperature resistance, compactness and relative permeability at the same time.

In order to achieve the above objectives, one aspect of the present disclosure provides a magnetic composite material composition, includes a magnetically soft alloy, a thermosetting resin, a curing agent, and an organic solvent; where the organic solvent contains at least two types of volatile solvents, and a difference between boiling points of the volatile solvents ranges from 100 to 170° C.

Further, the organic solvent includes a first volatile solvent, a second volatile solvent, and a third volatile solvent. Differences of boiling points of the first volatile solvent, the second volatile solvent and the third volatile solvent ranges from 5 to 40° C. and 80 to 150° C. successively.

Further, the first volatile solvent is selected from one or more of a group consisting of n-propyl acetate, isopropyl acetate, and methyl isopropyl ketone; the second volatile solvent is selected from one or more of a group consisting of n-butanol, isobutyl alcohol, and ethylene glycol monomethyl ether; the third volatile solvent is selected from one or more of a group consisting of diethylene glycol butyl ether, isophorone, and diethylene glycol monobutyl ether acetate.

Further, a weight ratio of the first volatile solvent, the second volatile solvent to the third volatile solvent is (2-5):(2-3):1.

Further, the magnetic composite material composition includes 100 parts of the magnetically soft alloy, 2 to 8 parts of the thermosetting resin, 1.6 to 7.2 parts of the curing agent, and 5 to 25 parts of the organic solvent by weight; preferably, the curing agent is selected from methyl nadie anhydride and/or nadic anhydride; the magnetically soft alloy is selected from one or more of a group consisting of Fe—Si magnetically soft alloy, Fe—Si—Al magnetically soft alloy, Fe—Si—Cr magnetically soft alloy. Fe—Ni magnetically soft alloy. Fe—Ni—Mo magnetically soft alloy, amorphous soft magnetic alloy, and soft magnetic nanocrystalline; more preferably, an epoxide equivalent of the thermosetting resin ranges from 150 to 220 g/eq, and the viscosity at 25° C. ranges from 8000 to 14000 cps.

Further, the magnetic composite material composition includes 100 parts of the magnetically soft alloy, 3 to 6 parts of the thermosetting resin, 2.4 to 5.4 parts of the curing agent, and 5 to 20 parts of the organic solvent.

Further, the magnetic composite material composition further includes a curing accelerator and a defoaming agent; preferably, the magnetic composite material includes 0.06 to 0.24 part of the curing accelerator and 0.017 to 0.08 part of the defoaming agent by weight; more preferably, the magnetic composite material includes 0.09 to 0.18 part of the curing accelerator and 0.02 to 0.06 part of the defoaming agent by weight.

In order to achieve the above objectives, another aspect of the present disclosure further provides a method for manufacturing a magnetic core for an inductor, includes: manufacturing a magnetic core for an inductor successively through casting, oscillation. curing in stages, cooling and demoulding by the above magnetic composite material provided in this disclosure; the curing in stages includes a first stage of the curing process, a second stage of the curing process, a third stage of the curing process and a fourth stage of the curing process; curing temperatures of the first stage of the curing process, the second stage of the curing process, the third stage of the curing process and the fourth stage of the curing process successively increase.

Further, the curing temperature of the first stage of the curing process ranges from 50 to 100° C.; the curing temperature of the second stage of the curing process ranges from 110 to 150° C.; the curing temperature of the third stage of the curing process ranges from 160 to 180° C.; the curing temperature of the fourth stage of the curing process ranges from 190 to 210° C.

Another aspect of the present disclosure provides a magnetic core for an inductor; the magnetic core for the inductor is manufactured by the manufacturing method provided above in this disclosure; the density of the magnetic core for the inductor ranges from 4 to 6 g/cm³, relative permeability ranges from 10 to 30, and a heat-resistant temperature ranges from 100 to 180° C.

By applying the technical solution of the present disclosure, the magnetic composite material composition is prepared. In one aspect, the magnetically soft alloy and the thermosetting resin may be cured and formed under the action of the curing agent. Since the thermosetting resin has good heat resistance, the magnetic composite material of the above composition has good high-temperature resistance. In another aspect, the organic solvent contains at least two types of volatile solvents. By limiting the difference between the boiling points of the volatile solvents within the above range, different types of the volatile solvents may be successively volatilized rather than rapidly volatilized at one time as the curing reaction undergoes during the preparation of the magnetic composite material. Therefore, a large amount of pores can be prevented from being produced on the surface and internal of the magnetic composite material composition, thereby enhancing the compactness and relative permeability of the magnetic composite material composition.

### BRIEF DESCRIPTION OF THE DRAWINGS

The drawings, which form a part of this disclosure, are used to provide a further understanding of the present disclosure. The exemplary embodiments of the present disclosure and the description thereof are used to explain the present disclosure, but do not constitute improper limitations to the present disclosure. In the drawings:

FIG. 1 is a Scanning Electron Microscope diagram (SEM diagram) of an internal cross section of the integrated inductor magnetic core manufactured according to Embodiment 1 of the present disclosure.

### DETAILED DESCRIPTION OF THE EMBODIMENTS

It is to be noted that the embodiments in this disclosure and the features in the embodiments may be combined with one another without conflict. The present disclosure will be described below in detail with reference to the embodiments.

As described in the background. the conventional integrated inductor magnetic core has a problem that the preparation process of the conventional integrated inductor is complicated. a coil is damaged during pressure casting, and the integrated inductor magnetic core is poor in high-temperature resistance (100 to 180° C.) and difficult to have good high-temperature resistance, compactness and relative permeability at the same time. In order to solve the above technical problem, this disclosure provides a magnetic composite material composition. The magnetic composite material composition includes a magnetically soft alloy, a thermosetting resin, a curing agent, and an organic solvent; the organic solvent contains at least two types of volatile solvents, and a difference between boiling points of the volatile solvents ranges from 100 to 170° C.

In one aspect, the magnetically soft alloy and the thermosetting resin may be cured and formed under the curing action of the curing agent. Since the thermosetting resin has good heat resistance, the magnetic composite material of the above composition has good high-temperature resistance. In another aspect, the organic solvent contains at least two types of volatile solvents. By limiting the difference between the boiling points of the volatile solvents within the above range, different types of the volatile solvents may be successively volatilized rather than rapidly volatilized at one time as the curing reaction undergoes during the preparation of the magnetic composite material. Therefore, a large amount of pores are prevented from being produced on the surface and internal of the magnetic composite material, thereby enhancing the compactness and relative permeability of the magnetic composite material.

In a preferred implementation, the organic solvent includes a first volatile solvent, a second volatile solvent, and a third volatile solvent. Differences of boiling points of the first volatile solvent, the second volatile solvent and the third volatile solvent successively range from 5 to 40° C. and 80 to 150° C. By limiting the differences of the boiling points of the first volatile solvent, the second volatile solvent and the third volatile solvent within the above range respectively, the volatilization rate of the first volatile solvent, the second volatile solvent and the third volatile solvent is further controlled, so that the porosity of the magnetic composite material after curing can be better reduced, and the compactness and the relative permeability of the magnetic composite material can be enhanced.

Further, the types of the first volatile solvent, the second volatile solvent, and the third volatile solvent may be selected according to the differences of the boiling points. In a preferred implementation, the first volatile solvent includes but is not limited to one or more of a group consisting of n-propyl acetate, isopropyl acetate, and methyl isopropyl ketone; the second volatile solvent includes but is not limited to one or more of a group consisting of n-butanol, isobutyl alcohol, and ethylene glycol monomethyl ether; the third volatile solvent includes but is not limited to one or more of a group consisting of diethylene glycol butyl ether, isophorone, and diethylene glycol monobutyl ether acetate.

In the above organic solvent, the n-propyl acetate (propyl acetate, chemical formula is C₅H₁₀O₂, and boiling point is 101.6° C.), the isopropyl acetate (chemical formula is C₅H₁₀O₂, and boiling point is 89° C.) and the methyl isopropyl ketone (chemical formula is C₅H₁₀O. and boiling point is 94 to 95° C.) are organic solvents with low boiling points and high volatility. The n-butanol (chemical formula is C₄H₁₀O, and boiling point is 117.5° C.), the isobutyl alcohol (chemical formula is C₄H₁₀O, and boiling point is 107.9° C.) and the ethylene glycol monomethyl ether (chemical formula is C₃H₈ O₂, and boiling point is 124 to 125° C.) are respectively organic solvents with relatively low boiling points and relatively high volatility. The diethylene glycol butyl ether (boiling point is 230.4° C.), the isophorone (chemical formula is C₉H₁₄O, and boiling point is 215.2° C.) and the diethylene glycol monobutyl ether acetate (chemical formula is C10H₂₀O₄, and boiling point is 246.4° C.) are respectively organic solvents with high boiling points and low volatilization rates. During the process of the preparation of the magnetic composite material composition, as the curing reaction undergoes, the organic solvents having low boiling points and high volatility volatilize firstly, then the organic solvents having relatively low boiling points and relatively high volatility volatilize, and the organic solvents having high boiling points and low volatilization rates are the last to volatilize. By adopting the volatile solvents having different boiling points and volatilization rates, a large amount of pores can be prevented from being produced on the surface and internal of the magnetic composite material, thereby enhancing the compactness and the relative permeability of the magnetic composite material composition.

In order to further enhance the compactness and the relative permeability of the magnetic composite material composition, in a preferred implementation, a weight ratio of the first volatile solvent, the second volatile solvent to the third volatile solvent is (2-5):(2-3):1.

In a preferred implementation. the magnetic composite material composition includes 100 parts of the magnetically soft alloy, 2 to 8 parts of the thermosetting resin, 1.6 to 7.2 parts of the curing agent, and 5 to 25 parts of the organic solvent by weight. By limiting the amount of the magnetically soft alloy, the thermosetting resin,the curing agent, and the organic solvent within the above range respectively, the magnetically soft alloy can be dispersed in the magnetic composite material composition more uniformly as the thermosetting resin is cured, so as to act as an important component of the magnetic core for the inductor to achieve an inductance function. In addition, the compactness and relative permeability of the magnetic composite material are enhanced. In addition, the high-temperature resistance of the magnetic composite material composition is also improved.

In order to improve the curing effect of the magnetic composite material composition, preferably, the curing agent includes but is not limited to methyl nadie anhydride and/or nadie anhydride, and the thermosetting resin includes but is not limited to epoxy resin. The magnetically soft alloy may adopt types commonly used in the field. In order to further enhance the relative permeability of the magnetic composite material composition, preferably, the magnetically soft alloy includes but is not limited to one or more of a group consisting of Fe—Si—Al magnetically soft alloy, Fe—Si magnetically soft alloy, Fe—Si—Cr magnetically soft alloy, Fe—Ni magnetically soft alloy, Fe—Ni—Mo magnetically soft alloy, amorphous soft magnetic alloy. and soft magnetic nanocrystalline. In order to further improve the curing effect of the thermosetting resin to conveniently subsequently perform injection molding on the magnetic composite material composition so as to manufacture the magnetic core for the inductor, more preferably, an epoxide equivalent of the thermosetting resin ranges from 150 to 220 g/eq, and the viscosity at 25° C. ranges from 8000 to 14000 eps.

In order to further enhance the compactness, the relative permeability and the high-temperature resistance, in a preferred implementation, the magnetic composite material composition includes 100 parts of the magnetically soft alloy, 3 to 6 parts of the thermosetting resin, 2.4 to 5.4 parts of the curing agent, and 5 to 20 parts of the organic solvent by weight.

In a preferred implementation. the magnetic composite material composition further includes a curing accelerator and a defoaming agent. The curing reaction efficiency of the magnetic composite material composition can be enhanced by using the curing accelerator. Bubbles produced in the magnetic composite material composition are removed by using the defoaming agent. In this way, adverse effects on the density of the magnetic core for the inductor manufactured subsequently due to the bubbles are prevented. In order to further enhance the curing reaction efficiency and remove the bubbles produced in the magnetic composite material composition more thoroughly, preferably, the magnetic composite material includes 0.06 to 0.24 part of the curing accelerator and 0.017 to 0.08 part of the defoaming agent by weight. In order to further enhance the curing reaction efficiency and remove the bubbles produced in the magnetic composite material composition more thoroughly, more preferably, the magnetic composite material includes 0.09 to 0.18 part of the curing accelerator and 0.02 to 0.06 part of the defoaming agent by weight.

In an optional implementation, the curing accelerator includes, but not limited to, 2,4,6-tris (dimethylaminomethyl) phenol and/or N, N-benzyldimethylamine; the defoaming agent includes, but not limited to, BYK-A525 (polyether-modified methylalkyl siloxane copolymer) and/or X-2320 (Shanghai Liqi Chemical Additives Co., Ltd.).

In an optional implementation, the magnetically soft alloy is granular, and D50 of the magnetically soft alloy ranges from 10 to 40 μm. By limiting the shape and D50 value of the magnetically soft alloy within the above range, the dispersion uniformity of the magnetically soft alloy in the magnetic composite material composition is improved, and the magnetically soft alloy material in the magnetic core for the inductor manufactured subsequently is uniformly distributed, so that the relative permeability of the magnetic core for the inductor manufactured subsequently is further enhanced.

A second aspect of the present disclosure provides a method for manufacturing a magnetic core for an inductor. The method for manufacturing a magnetic core for an inductor includes: manufacturing a magnetic core for an inductor successively through casting, oscillation, curing in stages, cooling and demoulding by the magnetic composite material; the curing in stages curing includes a first stage of the curing process, a second stage of the curing process, a third stage of the curing process, and a fourth stage of the curing process; curing temperatures of the first stage of the curing process, the second stage of the curing process, the third stage of the curing process, and the fourth in stages curing process successively increase.

Therefore, during oscillation, the magnetic composite material can be uniformly covered on a mold after casting, which facilitates a process for manufacturing the magnetic core for the inductor. By means of curing in stages, the volatile solvents having different boiling points and volatility are successively volatilized. As the curing reaction undergoes, the volatile solvents are successively volatilized rather than rapidly volatilized at one time. Therefore, a large amount of pores can be prevented from being produced on the surface and internal of the magnetic composite material, thereby enhancing the compactness and relative permeability of the magnetic composite material.

In order to successively volatilize the volatile solvents having different boiling points and volatility, that is to say, in order to respectively volatilize the first volatile solvent, the second volatile solvent, and the third volatile solvent at different stages of curing in stages to enhance the compactness and relative permeability of the magnetic composite material, in an optional implementation, the curing temperature of the first stages of curing process ranges from 50 to 100° C., the curing temperature of the second stages of curing process ranges from 110 to 150° C., the curing temperature of the third stages of curing process ranges from 160 to 180° C., and the curing temperature of the fourth stages of curing process ranges from 190 to 210° C.

A third aspect of this disclosure further provides a magnetic core for an inductor, where the magnetic core for the inductor is manufactured by the manufacturing method; or a density of the magnetic core for the inductor ranges from 4 to 6 g/cm³, a relative permeability ranges from 10 to 30, and a heat-resistant temperature ranges from 100 to 180° C. The magnetic core for the inductor may normally work at 100 to 180° C. and has good compactness and high relative permeability.

This disclosure is further described in detail below with reference to specific embodiments, and the embodiments can not be construed as limiting the scope of protection claimed in this disclosure.

It is to be noted that, relative permeability tests were performed on the magnetic core for the inductor manufactured in all of the embodiments and comparative examples in this disclosure by the following methods. Inductance values were tested by twisting a coil of 20 turns on the magnetic core for the inductor manufactured in the embodiments and comparative examples. The inductance test conditions were as followings: setting a voltage to 1V, setting a test frequency to 1 MHz, and calculating corresponding permeability according to the inductance value.

A calculation formula of the permeability of the magnetic core for the inductor is shown as follows:

$$μ = \frac{100 L * {l}_{e}}{0.4 π {N}^{2} * {A}_{e}} ,$$

where μ is the permeability of the core, L is inductance (H), N is the turn of a coil, Aₑ is an effective cross-sectional area of a magnetic circuit (cm²), and lₑ is an effective length of the magnetic circuit (cm).

A calculation formula of the effective cross-sectional area of the magnetic circuit of an annular inductor magnetic core is shown as follows:

$${A}_{e} = {π ( \frac{OD}{2} )}^{2} - {π ( \frac{LD}{2} )}^{2} ,$$

where Aₑ is the effective cross-sectional area of the magnetic circuit (cm²), OD is an external diameter of the annular inductor magnetic core (cm), and LD is an internal diameter of the annular inductor magnetic core (cm).

A calculation formula of the effective length of the magnetic circuit of the annular inductor magnetic core is shown as follows:

$${l}_{e} = \frac{π ( OD - LD )}{{Log}_{e} ( \frac{OD}{LD} )} ,$$

where lₑ is the effective length of the magnetic circuit (cm), OD is the external diameter of the annular inductor magnetic core (cm), and LD is the internal diameter of the annular inductor magnetic core (cm).

A high-temperature resistance test of a magnetic sheet was performed on the magnetic core for the inductor manufactured in all of the embodiments and comparative examples in this disclosure by using the following method. The magnetic core for the inductor manufactured in the embodiments and comparative examples was placed in an oven with a temperature being 180° C., pressing the magnetic core for the inductor every 20 min by using an iron pillar with a diameter being 5 mm, and then observing whether the core was sunken within 1 h.

### Embodiment 1

3 g epoxy resin (epoxide equivalent being 186 g/eq, and viscosity at 25° C. being 12000 cps), 8 g organic solvent and 0.03 g BYK-A525 were respectively added to an agate jar. The organic solvent was composed of n-propyl acetate, n-butanol and diethylene glycol butyl ether in a weight ratio of 4:2:1. Then 100 g of Iron-Silicon-Aluminum (FeSiAl) magnetically soft alloy powder (38.5 μm of D50 value) was added for ball milling, a ball-milling medium was a zirconium ball, a ball-milling speed was 240 rpm, and ball-milling time was 24 h. Finally, 2.4 g methyl nadic anhydride and 0.09 g 2,4,6-tris (dimethylaminomethyl) phenol were added, and ball milling was continuously performed for 15 min to obtain the mixed magnetic composite material composition.

The mixed magnetic composite material composition was taken from the agate jar and successively filtered by passing through a 100-mesh screen mesh, and vacuum deaeration was performed for 10 min, to obtain the magnetic composite material composition. In order to conveniently and more accurately evaluate the performance of the magnetic composite material composition, the magnetic composite material composition was directly poured into a mold with an external diameter being 16 mm, an internal diameter being 10 mm and a thickness being 3 mm, and the mold was placed on an oscillation table for oscillation, where a time of the oscillation was 20 min, a frequency of an oscillation motor was 50 Hz, and a rotational speed was 3000 rpm. After the oscillation was completed, the magnetic composite material composition on the surface of the mold was scraped for curing in stages. During curing in stages, a temperature at a first stage of the curing process was 80° C., and curing time was 2 h; a temperature at a second stage of the curing process was 120° C. and curing time was 2 h: a temperature at a third stage of the curing process was 180° C., and curing time was 2 h; and a temperature at a fourth stage of the curing process was 200° C., and curing time was 4 h. A heating rate of the curing process was 3° C./min. After curing in stages was completed, the magnetic composite material composition slurry after curing in stages was naturally cooled, and an integrated inductor magnetic core was obtained after demoulding.

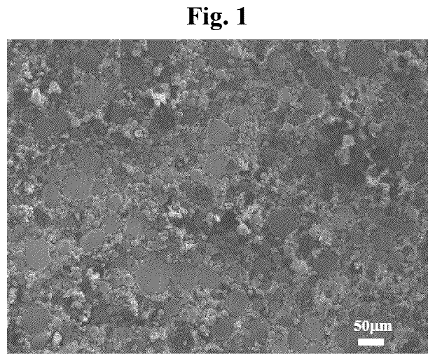

An internal cross section SEM of the integrated inductor magnetic core manufactured in Embodiment 1 was shown in FIG. 1. It may be seen that irregular particles having good compactness were distributed on the surface of the magnetic core for the inductor, and pores and cracks were not observed, which indicates that the manufactured inductor magnetic core has high compactness and no internal defects. In addition, the magnetic core for the inductor was not dented after a high-temperature resistance test was performed.

### Embodiment 2

A difference between this embodiment and Embodiment 1 was that: the amount of the thermosetting resin epoxy resin was 8 g, the amount of the curing agent methyl nadie anhydride is 6.4 g. and the amount of the curing accelerator 2,4,6-tris (dimethylaminomethyl) phenol was 0.24 g.

The magnetic core for the inductor was not dented after the high-temperature resistance test was performed.

### Embodiment 3

A difference between this embodiment and Embodiment 1 was that: the amount of the thermosetting resin epoxy resin was 2 g, the amount of the curing agent methyl nadic anhydride was 1.6 g. and the amount of the curing accelerator 2,4,6-tris (dimethylaminomethyl) phenol was 0.06 g.

The magnetic core for the inductor was not dented after the high-temperature resistance test was performed.

### Embodiment 4

A difference between this embodiment and Embodiment 1 was that: the amount of the thermosetting resin epoxy resin was 2 g, the amount of the curing agent methyl nadic anhydride was 1.6 g. the amount of the organic solvent was 25 g, and a weight ratio of the n-propyl acetate, the n-butanol and the diethylene glycol butyl ether was 2:2:1.

The magnetic core for the inductor was not dented after the high-temperature resistance test was performed.

### Embodiment 5

A difference between this embodiment and Embodiment 1 was that: the amount of the thermosetting resin epoxy resin was 8 g, the amount of the curing agent methyl nadie anhydride was 7.2 g, the amount of the organic solvent was 5 g, and a weight ratio of the n-propyl acetate, the n-butanol and the diethylene glycol butyl ether was 2:2:1.

The magnetic core for the inductor was not dented after the high-temperature resistance test was performed.

### Embodiment 6

A difference between this embodiment and Embodiment 1 was that: the amount of the thermosetting resin epoxy resin was 15 g.

The magnetic core for the inductor was dented after the high-temperature resistance test was performed.

### Embodiment 7

A difference between this embodiment and Embodiment 1 was that: the amount of the curing agent methyl nadic anhydride was 0.5 g.

The magnetic core for the inductor was dented after the high-temperature resistance test was performed.

### Embodiment 8

A difference between this embodiment and Embodiment 1 was that: the amount of the organic solvent was 50 g.

The magnetic core for the inductor was dented after the high-temperature resistance test was performed.

### Embodiment 9

A difference between this embodiment and Embodiment 1 was that: the weight ratio of the n-propyl acetate, the n-butanol to the diethylene glycol butyl ether was 5:3:1.

The magnetic core for the inductor was not dented after the high-temperature resistance test was performed.

### Embodiment 10

A difference between this embodiment and Embodiment 1 was that: the weight ratio of the n-propyl acetate, the n-butanol to the diethylene glycol butyl ether was 1:1:1.

The magnetic core for the inductor was dented after the high-temperature resistance test was performed.

### Embodiment 11

A difference between this embodiment and Embodiment 1 was that: the first volatile solvent was isopropyl acetate, and the third volatile solvent was isophorone; and the difference between the boiling points of the first volatile solvent and the second volatile solvent was 28.5° C., and the difference between the boiling points of the second volatile solvent and the third volatile solvent was 97.7° C.

The magnetic core for the inductor was not dented after the high-temperature resistance test was performed.

### Embodiment 12

A difference between this embodiment and Embodiment 1 was that: the first volatile solvent was methyl isopropyl ketone, and the second volatile solvent was isobutyl alcohol; and the difference between the boiling points of the first volatile solvent and the second volatile solvent ranges from 12.9 to 13.9° C., and the difference between the boiling points of the second volatile solvent and the third volatile solvent was 122.5° C.

The magnetic core for the inductor was not dented after the high-temperature resistance test was performed.

### Embodiment 13

A difference between this embodiment and Embodiment 1 was that: the third volatile solvent was diethylene glycol monobutyl ether acetate; and the difference between the boiling points of the first volatile solvent and the second volatile solvent was 15.9° C., and the difference between the boiling points of the second volatile solvent and the third volatile solvent was 128.9° C.

The magnetic core for the inductor was not dented after the high-temperature resistance test was performed.

### Embodiment 14

A difference between this embodiment and Embodiment 1 was that: the epoxide equivalent of the epoxy resin was 150 g/eq, and the viscosity was 8000 cps.

The magnetic core for the inductor was not dented after the high-temperature resistance test was performed.

### Embodiment 15

A difference between this embodiment and Embodiment 1 was that: the epoxide equivalent of the epoxy resin was 220 g/eq, and the viscosity was 14000 cps.

The magnetic core for the inductor was not dented after the high-temperature resistance test was performed.

### Embodiment 16

A difference between this embodiment and Embodiment 1 was that: the epoxide equivalent of the epoxy resin was 80 g/eq, and the viscosity was 50 cps.

The magnetic core for the inductor was dented after the high-temperature resistance test was performed.

### Embodiment 17

A difference between this embodiment and Embodiment 1 was that: during curing in stages, the temperature at the first stage of the curing process is 50° C.; the temperature at the second stage of the curing process is 110° C.; the temperature at the third stage of the curing process was 160° C.; and the temperature at the fourth stage of the curing process was 200° C.

The magnetic core for the inductor was not dented after the high-temperature resistance test was performed.

### Embodiment 18

A difference between this embodiment and Embodiment 1 was that: during curing in stages, the temperature at the first stage of the curing process was 100° C.; the temperature at the second stage of the curing process was 150° C.; the temperature at the third stage of the curing process was 180° C.; and the temperature at the fourth stage of the curing process was 200° C.

The magnetic core for the inductor was not dented after the high-temperature resistance test was performed.

### Embodiment 19

A difference between this embodiment and Embodiment 1 was that: during curing in stages, the temperature at the first stage of the curing process was 40°° C.; the temperature at the second stage of the curing process was 170° C.; the temperature at the third stage of the curing process was 200° C.; and the temperature at the fourth stage of the curing process was 250° C.

A manufactured sample had excessive holes and was unformed, so that density and permeability tests can not be performed.

### Embodiment 20

A difference between this embodiment and Embodiment 1 was that: the type of the magnetically soft alloy was Iron-Nickel (FeNi) magnetically soft alloy, and D50 was 40 μm.

The magnetic core for the inductor was not dented after the high-temperature resistance test was performed.

### Embodiment 21

A difference between this embodiment and Embodiment 1 was that: the sample was not oscillated after casting and molding.

The magnetic core for the inductor was not dented after the high-temperature resistance test was performed.

### Comparative Example 1

A difference between this example and Embodiment 1 was that: the used organic solvent was the n-propyl acetate only.

The magnetic core for the inductor was not dented after the high-temperature resistance test was performed.

The permeability test results of the magnetic core for the inductor of Embodiment 1 to 21 and Comparative example 1 of this disclosure are shown in Table 1.

TABLE 1

| | Density of the magnetic | |
|---|---|---|
| | core for the inductor | Relative permeability |
| | (g/cm³) | (μ′) |
| Embodiment 1 | 5.268 | 25.4 |
| Embodiment 2 | 4.848 | 19.2 |
| Embodiment 3 | 5.361 | 27.5 |
| Embodiment 4 | 5.259 | 25.1 |
| Embodiment 5 | 4.782 | 18.3 |
| Embodiment 6 | 4.482 | 11.2 |
| Embodiment 7 | 5.277 | 25.9 |
| Embodiment 8 | 4.763 | 17.1 |
| Embodiment 9 | 5.257 | 24.9 |
| Embodiment 10 | 5.241 | 23.2 |
| Embodiment 11 | 5.264 | 25.2 |
| Embodiment 12 | 5.265 | 25.3 |
| Embodiment 13 | 5.264 | 25.2 |
| Embodiment 14 | 5.270 | 25.6 |
| Embodiment 15 | 5.266 | 25.3 |
| Embodiment 16 | 5.251 | 24.3 |
| Embodiment 17 | 5.271 | 25.6 |
| Embodiment 18 | 5.267 | 25.4 |
| Embodiment 19 | — | — |
| Embodiment 20 | 5.718 | 17.1 |
| Embodiment 21 | 5.232 | 22.5 |
| Comparative | 4.801 | 18.8 |
| example 1 | | |

It may be seen from the above description that, in the above embodiments of the present disclosure, the following technical effects are realized.

By comparing Embodiment 1 to 8, it may be seen that: by limiting the amount of the magnetically soft alloy, the thermosetting resin, the curing agent, and the organic solvent within a preferred range of this disclosure, the magnetically soft alloy can be dispersed in the magnetic composite material composition more uniformly as the thermosetting resin was cured, so as to act as an important component of the magnetic core for the inductor to achieve an inductance function. In addition, the compactness and relative permeability of the magnetic composite material are enhanced. In addition, the high-temperature resistance of the magnetic composite material composition is also improved.

By comparing Embodiment 1, 9 and 10, it may be seen that: by limiting the weight ratio of the first volatile solvent, the second volatile solvent to the third volatile solvent within the preferred range of this disclosure, the compactness and relative permeability of the magnetic composite material composition are further enhanced.

By comparing Embodiment 1, 11 and 13 and Comparative example 1, it may be seen that: by using the volatile solvent of the preferred type of this disclosure and limiting the difference between the boiling points of the volatile solvents within the preferred range of this disclosure, different types of the volatile solvents may be successively volatilized rather than rapidly volatilized at one time as the curing reaction undergoes during the preparation of the magnetic composite material. Therefore, a large amount of pores can be prevented from being produced on the surface and internal of the magnetic composite material, thereby enhancing the compactness and relative permeability of the magnetic composite material.

By comparing Embodiment 1, 14 and 16, it may be seen that: by using the thermosetting resin of the preferred type of this disclosure, the curing effect of the thermosetting resin is improved to conveniently subsequently perform injection molding on the magnetic composite material composition, so as to manufacture the magnetic core for the inductor. By limiting the epoxide equivalent and viscosity of the thermosetting resin within the preferred type of this disclosure, the curing effect of the thermosetting resin is further improved to conveniently subsequently perform injection molding on the magnetic composite material composition, so as to manufacture the magnetic core for the inductor.

By comparing Embodiment 1, 17 and 19, it may be seen that: by adopting the curing temperature of the preferred type of this disclosure, the first volatile solvent, the second volatile solvent, and the third volatile solvent are respectively volatilized at different curing phases rather than rapidly volatilized at one time. Therefore, a large amount of pores can be prevented from being produced on the surface and internal of the magnetic composite material, thereby enhancing the compactness and relative permeability of the magnetic composite material.

By comparing Embodiment 1 and 20, it may be seen that: by using the magnetically soft alloy of the preferred type and particle size of this disclosure, the relative permeability of the magnetic composite material composition may be maintained at a high level.

By comparing Embodiment 1 and 21, it may be seen that: during oscillation, the magnetic composite material can be uniformly covered on a mold after casting, which facilitates a process for manufacturing the magnetic core for the inductor.

It is to be noted that terms “first”, “second” and the like in the description and claims of this disclosure are used for distinguishing similar objects rather than describing a specific sequence or a precedence order. It should be understood that the terms used in such a way may be exchanged where appropriate, in order that the implementations of this disclosure described here can be implemented in an order other than those described herein.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure all fall within the scope of protection of the present disclosure.

1. A magnetic composite material composition, comprising a magnetically soft alloy, a thermosetting resin, a curing agent, and an organic solvent, wherein the organic solvent containing at least two types of volatile solvents, and a difference between boiling points of the volatile solvents ranges from 100 to 170° C.

2. The magnetic composite material composition according to claim 1, wherein the organic solvent comprising a first volatile solvent, a second volatile solvent, and a third volatile solvent; and differences of boiling points of the first volatile solvent, the second volatile solvent and the third volatile solvent ranges from 5 to 40° C. and 80 to 150° C. successively.

3. The magnetic composite material composition according to claim 2, wherein the first volatile solvent is selected from one or more of a group consisting of n-propyl acetate, isopropyl acetate, and methyl isopropyl ketone; the second volatile solvent is selected from one or more of a group consisting of n-butanol, isobutyl alcohol, and ethylene glycol monomethyl ether; and the third volatile solvent is selected from one or more of a group consisting of diethylene glycol butyl ether, isophorone, and diethylene glycol monobutyl ether acetate.

4. The magnetic composite material composition according to claim 2 wherein a weight ratio of the first volatile solvent, the second volatile solvent to the third volatile solvent is (2-5):(2-3):1.

5. The magnetic composite material composition according to claim 1, wherein the magnetic composite material composition comprising 100 parts of the magnetically soft alloy, 2 to 8 parts of the thermosetting resin, 1.6 to 7.2 parts of the curing agent, and 5 to 25 parts of the organic solvent by weight;
preferably, the curing agent is selected from methyl nadic anhydride and/or nadic anhydride, and the magnetically soft alloy is selected from one or more of a group consisting of Fe—Si magnetically soft alloy, Fe—Si—Al magnetically soft alloy, Fe—Si—Cr magnetically soft alloy, Fe—Ni magnetically soft alloy, Fe—Ni—Mo magnetically soft alloy, amorphous soft magnetic alloy, and soft magnetic nanocrystalline; and
more preferably, an epoxide equivalent of the thermosetting resin ranges from 150 to 220 g/eq, and the viscosity at 25° C. ranges from 8000 to 14000 cps.

6. The magnetic composite material composition according to claim 5, wherein the magnetic composite material composition comprising 100 parts of the magnetically soft alloy, 3 to 6 parts of the thermosetting resin, 2.4 to 5.4 parts of the curing agent, and 5 to 20 parts of the organic solvent by weight.

7. The magnetic composite material composition according to claim 5, wherein the magnetic composite material composition further comprising a curing accelerator and a defoaming agent;
preferably, the magnetic composite material comprising 0.06 to 0.24 part of the curing accelerator and 0.017 to 0.08 part of the defoaming agent by weight; and
more preferably, the magnetic composite material comprising 0.09 to 0.18 part of the curing accelerator and 0.02 to 0.06 part of the defoaming agent by weight.

8. A method for manufacturing a magnetic core for an inductor, comprising: manufacturing a magnetic core for an inductor successively through casting, oscillation, curing in stages, cooling and demoulding by the magnetic composite material according to claim 1, wherein the curing in stages comprising a first stage of the curing process, a second stage of the curing process, a third stage of the curing process, and a fourth stage of the curing process; curing temperatures of the first stage of the curing process, the second stage of the curing process, the third stage of the curing process, and the fourth stage of the curing process successively increase.

9. The method for manufacturing a magnetic core for an inductor according to claim 8, wherein the curing temperature of the first stage of the curing process ranges from 50 to 100° C.; the curing temperature of the second stage of the curing process ranges from 110 to 150° C.; the curing temperature of the third stage of the curing process ranges from 160 to 180° C.; and the curing temperature of the fourth stage of the curing process ranges from 190 to 210° C.

10. A magnetic core for an inductor, wherein the magnetic core for the inductor manufactured by the manufacturing method according to claim 8;
preferably, a density of the magnetic core for the inductor ranges from 4 to 6g/cm³, relative permeability ranges from 10 to 30, and a heat-resistant temperature ranges from 100 to 180° C.

11. The magnetic composite material composition according to claim 3, wherein a weight ratio of the first volatile solvent. the second volatile solvent to the third volatile solvent is (2-5):(2-3):1.

12. The magnetic composite material composition according to claim 5, wherein the organic solvent comprising a first volatile solvent, a second volatile solvent, and a third volatile solvent; and differences of boiling points of the first volatile solvent, the second volatile solvent and the third volatile solvent ranges from 5 to 40° C. and 80 to 150° C. successively.

13. The magnetic composite material composition according to claim 5, wherein the first volatile solvent is selected from one or more of a group consisting of n-propyl acetate, isopropyl acetate, and methyl isopropyl ketone; the second volatile solvent is selected from one or more of a group consisting of n-butanol, isobutyl alcohol, and ethylene glycol monomethyl ether; and the third volatile solvent is selected from one or more of a group consisting of diethylene glycol butyl ether, isophorone, and diethylene glycol monobutyl ether acetate.

14. The magnetic composite material composition according to claim 5, a weight ratio of the first volatile solvent, the second volatile solvent to the third volatile solvent is (2-5):(2-3):1.

15. The method for manufacturing a magnetic core for an inductor according to claim 8, wherein the organic solvent comprising a first volatile solvent, a second volatile solvent, and a third volatile solvent; and differences of boiling points of the first volatile solvent, the second volatile solvent and the third volatile solvent ranges from 5 to 40° C. and 80 to 150° C. successively.

16. The method for manufacturing a magnetic core for an inductor according to claim 8, wherein the first volatile solvent is selected from one or more of a group consisting of n-propyl acetate, isopropyl acetate, and methyl isopropyl ketone; the second volatile solvent is selected from one or more of a group consisting of n-butanol, isobutyl alcohol, and ethylene glycol monomethyl ether; and the third volatile solvent is selected from one or more of a group consisting of diethylene glycol butyl ether, isophorone, and diethylene glycol monobutyl ether acetate.

17. The method for manufacturing a magnetic core for an inductor according to claim 8, wherein a weight ratio of the first volatile solvent, the second volatile solvent to the third volatile solvent is (2-5):(2-3):1.

18. The method for manufacturing a magnetic core for an inductor according to claim 8, wherein the magnetic composite material composition comprising 100 parts of the magnetically soft alloy, 2 to 8 parts of the thermosetting resin, 1.6 to 7.2 parts of the curing agent, and 5 to 25 parts of the organic solvent by weight;
preferably, the curing agent is selected from methyl nadic anhydride and/or nadic anhydride, and the magnetically soft alloy is selected from one or more of a group consisting of Fe—Si magnetically soft alloy, Fe—Si—Al magnetically soft alloy, Fe—Si—Cr magnetically soft alloy, Fe—Ni magnetically soft alloy, Fe—Ni—Mo magnetically soft alloy, amorphous soft magnetic alloy, and soft magnetic nanocrystalline; and
more preferably, an epoxide equivalent of the thermosetting resin ranges from 150 to 220g/eq, and the viscosity at 25° C. ranges from 8000 to 14000 cps.

19. The method for manufacturing a magnetic core for an inductor according to claim 8, wherein the magnetic composite material composition comprising 100 parts of the magnetically soft alloy, 3 to 6 parts of the thermosetting resin, 2.4 to 5.4 parts of the curing agent, and 5 to 20 parts of the organic solvent by weight.

20. The method for manufacturing a magnetic core for an inductor according to claim 8, wherein the magnetic composite material composition comprising 100 parts of the magnetically soft alloy, 3 to 6 parts of the thermosetting resin, 2.4 to 5.4 parts of the curing agent, and 5 to 20 parts of the organic solvent by weight.
